(19) United States
(12) Patent Application Publication
(10) Pub. No.: US 2017/0291691 A1
(43) Pub. Date: Oct. 12, 2017

(54) Assistance method for assisting flying of an aircraft with restriction of possibilities of adjusting the flying parameters depending on the context, and corresponding device

(71) Applicant: DASSAULT AVIATION, PARIS (FR)

(72) Inventors: Jérôme BARRAL, Paris (FR); Patrick DARSES, ISTRES (FR)

(21) Appl. No.: 15/484,616

(22) Filed: Apr. 11, 2017

(30) Foreign Application Priority Data
Apr. 12, 2016 (FR) FR 16 00620

(51) Int. Cl. B64C 13/18; B64D 43/02; G05D 1/10

(52) U.S. Cl. CPC B64C 13/18; G05D 1/101; B64D 43/02; G08G 5/003

(57) ABSTRACT

An assistance method for assisting flying of an aircraft with restriction of possibilities of adjusting the flying parameters depending on the context, and corresponding device are provided. The assistance method for assisting flying of an aircraft includes the steps of: configuring at least one flying mode, the configuration comprising selecting a flying mode selected from among an available flying mode and entering at least one flying setpoint associated with the selected flying mode, presenting the or each configured flying mode, engaging at least one configured flying mode, and flying of the aircraft by an automatic pilot system of the aircraft based on the flying setpoint of the or each engaged flying mode. The method also includes a step for collecting at least one avionics parameter representative of a flying context, and a step for restricting configuration possibilities of the flying modes based on the or each collected avionics parameter.

This claims the benefit of French Patent Application FR 16 00620, filed Apr. 12, 2016 and hereby incorporated by reference herein.

The present invention relates to a method for assisting flying of an aircraft, of the type comprising an automatic pilot system with a plurality of preprogrammed flying modes, the method comprising the following steps:

configuring at least one flying mode so as to form a configured flying mode, said configuration comprising:
selecting, by a user, a flying mode selected from among at least one available flying mode taken from among the preprogrammed flying modes, and
entering at least one flying setpoint associated with said selected flying mode, presenting, to the user, the or each configured flying mode and the associated flying setpoint,

engaging at least one configured flying mode, said configured flying mode becoming an engaged flying mode, and

flying of the aircraft by the automatic pilot system based on the flying setpoint of the or each engaged flying mode.

The method also relates to a device for assisting flying of an aircraft, the type comprising:

a memory in which a plurality of preprogrammed flying modes are stored,

a mode configuring system for configuring at least one flying mode, so as to form a configured flying mode, said control interface comprising:
a flying mode selector for the selection, by a user, a flying mode selected from among at least one available flying mode taken from among the preprogrammed flying modes, and
a setpoint entry member for the entry, by a user or by an avionics system, of at least one flying setpoint associated with said selected flying mode,

a presenting member for presenting, to the user, the or each configured flying mode and the associated flying setpoint,

a mode engaging system for engaging at least one configured flying mode, said configured flying mode becoming an engaged flying mode, and

an automatic pilot system of the aircraft, configured to fly the aircraft based on the flying setpoint of the or each engaged flying mode.

### BACKGROUND

It is known to fly an aircraft with assistance from an automatic pilot system of the aircraft. This automatic pilot system can generally be broken down into a first, so-called “autopilot” module, intended to steer the trajectory of the aircraft, and a second so-called “auto-throttle” module, intended to control the speed of the aircraft.

The automatic pilot system flies the aircraft based on flying parameters, which include flying modes selected by the pilot and flying setpoints associated with said flying modes. The flying modes are generally selected by the pilot through a specific control unit called “guidance panel”. The flying setpoints are entered either by the pilot, who then enters them by using the guidance panel, or by an automatic system like the “Flight Management System” (FMS), which develops these setpoints itself before sending them to the automatic pilot system or provides a default setpoint. Once a flying mode has been selected by the pilot and the associated flying setpoint has been entered, this flying mode is said to be “configured”. A configured flying mode can next be engaged by the pilot, such that the automatic pilot system flies the aircraft based on the flying setpoint associated with said flying mode. A distinction is made between so-called “active” configured flying modes, which are ready to be engaged directly by the pilot, and so-called “armed” flying modes, which are waiting for activation conditions to be met in order to be able to be activated.

Flying modes are known with manual entry, called “basic modes”; these flying modes comprise:

a “roll mode”, a “heading mode”, and “track mode” for controlling the horizontal trajectory of the aircraft,

a “Path mode”, “VS mode”, “CLB mode”, “DESC mode”, “ASEL mode” and “ALT mode” to control the vertical trajectory of the aircraft (list may vary from one aircraft to another), and

a “speed mode” and a “Mach mode” for controlling the speed of the aircraft.

The flying setpoints associated with these flying modes are chosen by the pilot using the guidance panel.

Also known are so-called “higher” flying modes that allow automatic sequencing of flying setpoints developed and entered automatically by the FMS: these higher modes comprise a so-called “Lateral Navigation” (LNAV) mode for controlling the horizontal trajectory of the aircraft, a so-called “Vertical Navigation” (VNAV) mode for controlling the vertical trajectory of the aircraft, and a so-called “Speed Navigation” (SNAV) mode for controlling the speed of the aircraft.

Lastly, flying modes are known that allow the aircraft to be controlled both in terms of trajectory and speed. This is in particular the case of the “Approach” mode, which makes it possible to set flying setpoints for both vertical trajectory and horizontal trajectory. The flying setpoints associated with this flying mode are generally determined by the FMS.

Irrespective of the flying parameters (modes and setpoints) entered in the automatic pilot system, the pilot can choose whether to engage automatic tracking of these parameters by engaging the autopilot and/or the auto-throttle. If he does not engage the autopilot, he will have to ensure proper maintenance of the trajectory using the control stick. If he does not engage the auto-throttle, he it will have to ensure proper maintenance of the speed using the throttle.

A guidance panel 10 of a device to assist with flying of an aircraft of the state of the art is shown in FIG. 1. As shown in this Figure, the guidance panel is divided into three zones 12, 14, 16 each intended to adjust a flying axis: a first zone 12 is thus intended primarily to select the flying mode in terms of speed and to adjust the associated flying setpoint, a second zone 14 is primarily intended to select the piloting mode in terms of horizontal trajectory and to adjust the associated flying setpoint, and a third zone 16 is primarily intended to select the piloting mode in terms of vertical trajectory and to adjust the associated flying setpoint.

The first zone 12 comprises a double coil turret 20 for selecting one mode from among the Speed and Mach modes, choosing the origin of the setpoint between a setpoint developed by the FMS and a setpoint selected by the pilot, and adjusting the associated flying setpoint, a viewer 22 displaying the setpoint adjusted using the double coil turret 20, and a button 26 for engaging/disengaging the auto-throttle. The second zone 14 comprises a double coil turret 30 for selecting the heading or track mode and adjusting the associated setpoint, a viewer 32 displaying the flying setpoint adjusted using the double coil turret 30, and a button 36 for selecting/deselecting the higher flying mode in terms of horizontal trajectory (LNAV). The third zone 16 comprises a button 40 for selecting a mode from among the path and vertical speed modes, a button 42 making it possible to select the “ALT” mode, a button 44 making it possible to select the “climb” mode, a knob 46 for adjusting a setpoint associated with the selected mode via the button 40 (VS or Path mode), and a button 48 making it possible to select the higher flying mode in terms of vertical trajectory (VNAV). This zone 16 also comprises a double coil turret 49 allowing the selection of the safe altitude (ASEL).

The guidance panel 10 also comprises a fourth zone 18, inserted between the second and third zones 14, 16. This fourth zone 18 comprises a first button 37 for engaging/disengaging the autopilot, and a second button 38 for selecting a priority flying axis in flying the aircraft between vertical trajectory control on the one hand, and speed and horizontal trajectory control on the other hand.

The adjustment of the flying parameters is generally shown on a monitor separate from the guidance panel and called “Flight Mode Annunciation” (FMA).

FIG. 2 thus shows a FMA 50 belonging to the same flying assistance device as the guidance panel 10. This FMA has a region 52 indicating the engaged or disengaged status of the auto-throttle, enriched by the active flying mode for the flying of the aircraft in terms of speed, a region 56 displaying the active flying mode for flying the aircraft in terms of horizontal trajectory, a region 54 displaying the setpoint associated with this active horizontal mode, a region 58 displaying the active flying mode for flying the aircraft in terms of vertical trajectory, a region 59 displaying the setpoint associated with this active vertical mode, a region 60 displaying the engaged or disengaged status of the autopilot, enriched by information on the priority flying axis, and lastly, regions 62 and 64 respectively displaying the armed flying mode of the aircraft in terms of horizontal trajectory and the armed flying mode of the aircraft in terms of vertical trajectory. One can also see that in the illustrated example, the auto-throttle and autopilot are both engaged, and that the active flying modes are the speed, heading and vertical speed modes, while the approach modes (the LOC mode capturing the electrical beam on the lateral axis and the GS mode capturing the electrical beam on the vertical axis) are armed.

### SUMMARY OF THE INVENTION

The known flying assistance devices nevertheless have many drawbacks. First, there is the separation existing between the adjustment of the flying parameters via the guidance panel and the display of this adjustment on the FMA. Next, there is the fact that all of the adjustment commands of the flying modes and setpoints are accessible at all times. This complicates the pilot's task in adjusting the flying parameters and facilitates human error. Lastly, the device making it possible to avoid human error (through announcements such as “CHECK ASEL” asking the pilot to verify the setpoints, for example the safe altitude setpoint) is very limited and does not cover the spectrum of possible errors, which leads the pilot into dangerous situations where it will be difficult for him to identify the error in question and correct it.

One aim of the invention is thus to reduce errors by aircraft pilots. Another aim is to lighten their workload.

To that end, a method of the aforementioned type is provided, also comprising a step for collecting at least one avionics parameter representative of a flying context, and a step for restricting configuration possibilities of the flying modes based on the or each collected avionics parameter.

According to specific embodiments of the invention, the flying assistance method also comprises one or more of the following features, considered alone or according to any technically possible combination(s):

the step for restricting configuration possibilities comprises the following sub-steps:
identifying at least one flying parameter compatible or incompatible with the or each collected avionics parameter, and
establishing constraints to prevent the selection of a flying mode and/or the entry of a flying setpoint that is not a compatible flying parameter;

establishing constraints comprises restricting the available flying modes to only the compatible flying parameters;

entering the or each flying setpoint associated with the selected flying mode comprises selecting said flying setpoint from within a range of authorized flying setpoints, and establishing constraints comprises restricting the range of authorized flying setpoints only to the compatible flying parameters;

displaying the or each configured flying mode comprises displaying said configured flying mode and the associated flying setpoint on a monitor;

to select the selected flying mode, the user interacts with a configuration system, said configuration system being formed by the monitor or by a dedicated interface system;

the preprogrammed flying modes comprise at least one flying mode from among the following modes: “roll ” mode, “heading” mode, “track” mode, “pass” mode, “vertical speed” mode, “client” mode, “descent” mode, “ALT mode”, “speed” mode, “Mach” mode, “approach” mode, “LNAV” mode, “VNAV” mode and “SNAV”; and

the collected avionics parameter(s) comprise at least one avionics parameter from among: a configuration of the aircraft, a state of the aircraft, a mission context of the aircraft, environmental data of the aircraft, a current altitude of the aircraft and a current flight phase of the aircraft.

A device to assist with flying an aircraft, of the aforementioned type, is also provided also comprising an avionics parameter collector to collect at least one avionics parameter of the aircraft, and a command limiter to restrict the flying mode configuration possibilities based on the or each collected avionics parameter.

According to specific embodiments of the invention, the flying assistance device also comprises one or more of the following features, considered alone or according to any technically possible combination(s):

the command limiter comprises a compatibility checker to identify at least one flying parameter compatible or incompatible with the or each collected avionics parameter, and a constraint establisher configured to establish constraints to prevent the selection of a flying mode and/or the entry of a flying setpoint that is not a compatible flying parameter;

the constraint establisher is configured to restrict the available flying modes to only the compatible flying parameters;

the input member is suitable for allowing the selection of the flying setpoint associated with the selected flying mode selected from within a range of authorized flying setpoints, and the constraint establisher is configured to restrict the range of authorized flying setpoints only to the compatible flying parameters;

the display member comprises a monitor and a control module configured to control the display, on the monitor, of the or each configured flying mode and the associated flying setpoint;

the mode configuration system is formed by the monitor or by a dedicated interface sy stem;

the preprogrammed flying modes comprise at least one flying mode from among the following modes: “roll ” mode, “heading” mode, “track” mode, “pass” mode, “vertical speed” mode, “client” mode, “descent” mode, “ALT mode”, “speed” mode, “Mach” mode, “approach” mode, “LNAV” mode, “VNAV” mode and “SNAV”; and

the collected avionics parameter(s) comprise at least one avionics parameter from among: a configuration of the aircraft, a state of the aircraft, a mission context of the aircraft, environmental data of the aircraft, a current altitude of the aircraft and a current flight phase of the aircraft.

### BRIEF SUMMARY OF THE DRAWINGS

Other features and advantages of the invention will appear upon reading the following description, provided as an example and done in reference to the appended drawings, in which:

FIG. 1 is a front view of a guidance panel of a flying assistance device of the state of the art,

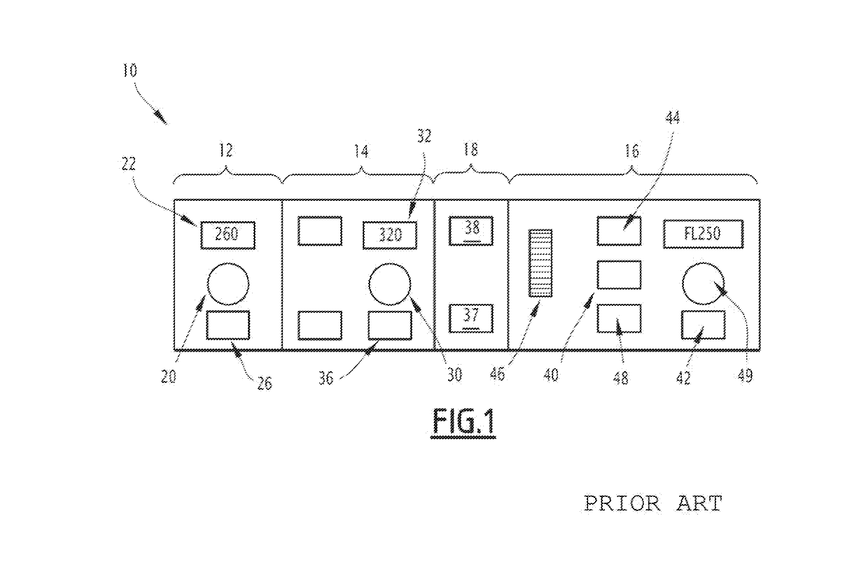

FIG. 2 is a front view of a flight mode annunciation of the flying assistance device of FIG. 1,

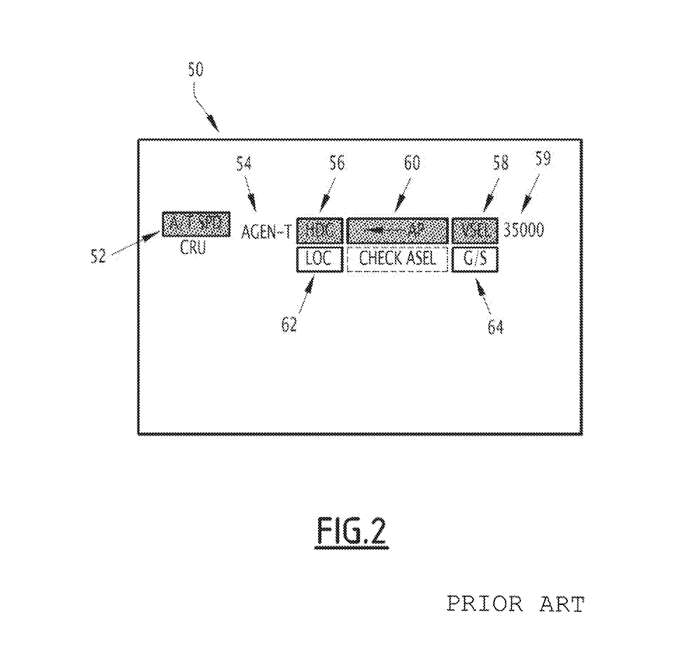

FIG. 3 is a schematic view of a flying assistance device according to an embodiment of the invention,

FIG. 4 is an illustration of a compatibility checker of the flying assistance device of FIG. 3, and

FIG. 5 is a diagram illustrating a method implemented by the flying assistance device of FIG. 3.

### DETAILED DESCRIPTION

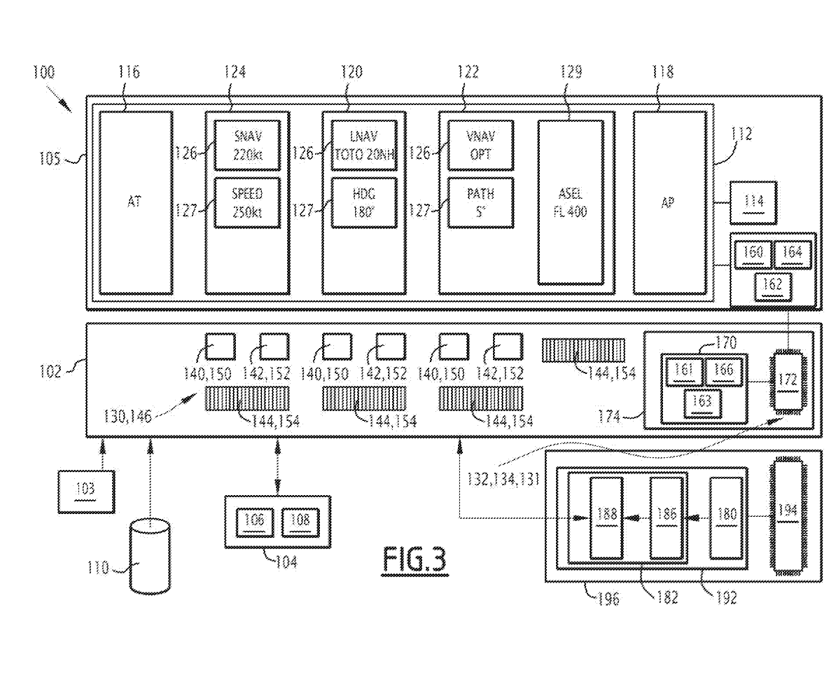

The flying assistance device 100 shown in FIG. 3 is onboard an aircraft. This device 100 comprises an automatic pilot system 104 of the aircraft, configured to fly the aircraft automatically based on flying parameters communicated to said flying system 104, a control interface 102 for a pilot of the aircraft to adjust said flying parameters, a flight management system 103 (FMS) for automatically computing flying parameters that are variable over time suitable for following a flight plan configured by the pilot, and a presenting member 105 for presenting the pilot the adjustment of the flying parameters.

The automatic pilot system 104 is suitable for flying the aircraft along three flying axes, said flying axes being made up of: the horizontal trajectory of the aircraft, the vertical trajectory of the aircraft, and the speed of the aircraft. To that end, the automatic pilot system 104 comprises, in a known manner, an auto-throttle 106, first controlling the speed of the aircraft, and an autopilot 108, for controlling the horizontal and vertical trajectory of the aircraft. The flying parameters based on which the automatic pilot system 104 flies the aircraft comprise active flying modes, selected from among preprogrammed flying modes stored in a memory 110 of the flying assistance device 100, and flying setpoints associated with said active flying modes and selected from within variation ranges of these setpoints.

The preprogrammed flying modes typically comprise the following known flying modes:

the “roll”, “heading”, “track” and “LNAV” modes, intended exclusively for controlling the horizontal trajectory of the aircraft,

the “path”, “vertical speed”, “climb”, “descent”, “ASEL”, “ALT” and “VNAV” modes, intended exclusively for controlling the vertical trajectory of the aircraft (non-exhaustive list),

the “speed”, “Mach” and “SNAV” modes, intended exclusively for controlling the speed of the aircraft, and

the “approach” mode, intended for controlling the aircraft along the flying axes in terms of horizontal trajectory and vertical trajectory.

The flying setpoints associated with said flying modes are, for the “roll”, “heading”, “track”, “path”, “vertical speed”, “climb”, “descent”, “ASEL”, “ALT”, “speed” and “Mach” basic modes, entered either manually by the pilot through the control interface 102, or automatically by another avionics system, for example the controller-pilot datalink communication (CPDLC) system. For the “LNAV”, “VNAV” and “SNAV” modes, which constitute higher flying modes, the flying setpoints are entered automatically by the FMS.

The presenting member 105 is configured to show the pilot configured flying modes on the one hand, whether they are active or simply armed, as well as the flying setpoints associated with said configured flying modes, and the engaged or non-engaged state of the autopilot 108 and the auto-throttle 106, on the other hand. To that end, the presenting member 105 comprises, in the illustrated example, a monitor 112, in particular a touchscreen, and a display module 114 for controlling the display on the monitor 112 of the configured flying modes, the flying setpoints associated with said modes, and information representative of the engaged or disengaged state of the autopilot 108 and the auto-throttle 106.

The display module 114 is in particular configured to control the display of:

the engaged or disengaged status of the auto-throttle 106 in a first region 116 of the monitor 112, the engaged status being symbolized by the display of the mention “AT” on a background in a first color, for example green, and the disengaged status being symbolized by the display of the same mention “AT” on a background of a second color, for example black,

the engaged or disengaged status of the autopilot 108 in a second region 118 of the monitor 112, the engaged status being symbolized by the display of the mention “AP” on a background in a first color, for example green, and the disengaged status being symbolized by the display of the same mention “AP” on a background of a second color, for example black,

in a third region 120 of the monitor 112, configured flying modes intended exclusively for controlling the horizontal trajectory of the aircraft, with their respective flying setpoints,

in a fourth region 122 of the monitor 112, configured flying modes intended exclusively for controlling the vertical trajectory of the aircraft, with their respective flying setpoints, and

in a fifth region 124 of the monitor 112, configured flying modes intended exclusively for controlling the speed of the aircraft, with their respective flying setpoints.

Each of the third, fourth and fifth regions 120, 122, 124 is divided into two sub-regions 126, 127. The display module 114 is configured to display:

in a first 126 of said sub-regions, a first flying mode configured by the pilot, active, with the associated flying setpoint, and

in a seconds 127 of said sub-regions, a possible second flying mode, configured by the pilot, armed, with the associated flying setpoint.

The fourth region 122 further comprises a third sub-region 129. The control module 114 is configured to display, in said third sub-region 129, a safety altitude of the aircraft, entered by the pilot or by an avionics system of the aircraft, this safety altitude constituting a flying setpoint applicable to each of the configured flying modes intended for controlling the speed of the vertical trajectory of the aircraft.

The display module 114 is also configured to change the color of the background on which the flying modes are displayed based on the armed, activated and disengaged, or activated and engaged status of said flying modes.

The display module 114 is preferably made in the form of a software program stored in a memory and able to be executed by a processor, associated with said memory, the processor and the memory together forming an information processing unit included in the display member 105. Alternatively, the display module 114 is at least partially made in the form of a programmable logic component, or in the form of a dedicated integrated circuit, included in the display member 105.

The presenting member 105 thus gives the pilot clear feedback on the state (engaged or disengaged) of the autopilot and the auto-throttle, and the state of the active and armed modes as well as the flying setpoints associated with these modes.

The control interface 102 comprises a mode configuration system 130 for configuration by the pilot, for each flying axis of the aircraft (horizontal trajectory, vertical trajectory and speed), of flying modes, chosen from among the preprogrammed flying modes, intended to fly the aircraft along said flying axis. The control interface 102 also comprises a mode activation system 131, for activating armed flying modes, a mode engagement system 132, for engaging active flying modes, and an engagement/disengagement system 134 of the automatic pilot sy stem 104.

The system 130 comprises, for each of the flying axes of the aircraft:

a sub-region selector 140, for selecting the first or second sub-region 126, 127 of the region 120, 122, 124 of the monitor 112 associated with said flying axis,

a mode selector 142, for selecting a flying mode selected from among at least one available flying mode taken from among the preprogrammed flying modes intended exclusively for flying the aircraft along said flying axis, and

an entry member 144, for entering a flying setpoint associated with said selected flying mode, this setpoint being selected from within an authorized flying setpoint range.

In the illustrated example, the system 130 is formed by a dedicated interface system 146 positioned below the monitor 112. Alternatively, this dedicated interface system 146 is positioned in another location of the cockpit of the aircraft. Also alternatively, the system 130 is formed at least in part by the monitor 112, or by a voice command system.

The dedicated interface system 146 comprises, for each flying axis of the aircraft, a first button 150, making up the sub-region selector 140, a second button 152, making up the mode selector 142, and a knob 154, making up the entry member 144. In the illustrated example, these buttons 150, 152 and knob 154 are positioned below the region 120, 122, 124 of the monitor 112 associated with said flying axis of the aircraft.

The first button 150 is suitable for each pressure exerted thereon to change the selection of the first and second sub-regions 126, 127 of the region 120, 122, 124 of the monitor 112 associated with the flying axis.

The second button 152 is suitable for each pressure exerted thereon to cause the selection of a flying mode selected from among the or each available flying mode for the flying axis.

The knob 154 is suitable for the rotation thereof to cause the selection of a flying setpoint selected from within the range of authorized flying setpoints associated with the selected flying mode.

In order to show the pilot which of the first and second sub-regions 126, 127 of each of the regions 120, 122, 124 of the monitor 112 is selected, the display module 114 is preferably configured to display information representative of this selection on the monitor 112; this representative information typically consists of a box, for example cyan-colored, surrounding the selected sub-region 126 or 127.

Furthermore, in order to inform the pilot which flying mode is being selected, the display module 114 is preferably configured to display text indicating the selected flying mode on the monitor 112, in the selected sub-region 126 or 127. This text is advantageously displayed in a first color, for example gray, as long as the selected flying mode has not been configured, and in a second color, for example cyan or green, once the selected flying mode has been configured.

The mode activation system 131 comprises a touch-sensitive sensor 160 to detect a contact zone on the monitor 112, and a deduction member 161 to deduce an activation instruction of one of the armed flying modes from the contact zone detected by the sensor 160.

The touch-sensitive sensor 160 is configured to detect any contact by the pilot on the monitor 112 and to identify the zone of the monitor 112 that has been touched, in particular to identify whether the touched zone belongs to the second sub-region 127 of one of the third, fourth and fifth regions 120, 122, 124 of the monitor 112. The deduction member 161 is configured to deduce an activation instruction for the armed flying mode displayed in the touched sub-region.

Alternatively, the mode activation system 131 is made up of a voice command system.

The mode engagement system 132 also comprises a touch-sensitive sensor 162 in order to detect a contact zone on the monitor 112, this touch-sensitive sensor 162 preferably being combined with the touch-sensitive sensor 160. The mode engagement system 132 also comprises a deduction member 163 to deduce an engagement or disengagement instruction of one of the active flying modes from the contact zone detected by the sensor 162.

The touch-sensitive sensor 162 is configured to detect any contact by the pilot on the monitor 112 and to identify the zone of the monitor 112 that has been touched, in particular to identify whether the touched zone belongs to the first sub-region 126 of one of the third, fourth and fifth regions 120, 122, 124 of the monitor 112. The deduction member 163 is configured to deduce an engagement instruction for the active flying mode displayed in the touched sub-region.

Alternatively, the mode engagement system 132 is made up of a voice command system.

The engagement/disengagement system 134 of the automatic pilot system 104 also comprises a touch-sensitive sensor 164 in order to detect a contact zone on the monitor 112, this touch-sensitive sensor 164 preferably being combined with the touch-sensitive sensor 160. The engagement/disengagement system 134 also comprises a determination member 166 to determine an engagement or disengagement instruction of the auto-throttle 106 or the autopilot 108 from the contact zone detected by the sensor 164.

The touch-sensitive sensor 164 is configured to detect any contact by the pilot on the monitor 112 and to identify the zone of the monitor 112 that has been touched, in particular to identify whether the touched zone belongs to one of the first and second regions 116, 118 of the monitor 112 and to which of said regions 116, 118 the touched zone belongs. The determination member 166 is configured to determine an engagement instruction of the auto-throttle 106 when the auto-throttle 106 is disengaged and the first region 116 is touched, a disengagement instruction of the auto-throttle 106 when the auto-throttle 106 is engaged and the first region 116 is touched, an engagement instruction of the autopilot 108 when the autopilot 108 is disengaged and the second region 118 is touched, and a disengagement instruction of the autopilot 108 when the autopilot 108 is engaged and the second region 118 is touched.

Alternatively, the engagement/disengagement system 134 is made up of a voice command system.

In the example embodiment of the invention, the deduction members 161, 163 and the determination member 166 are made in the form of software programs stored in a memory 170 and able to be executed by a processor 172, associated with the memory 170, the processor 172 and the memory 170 together forming an information processing unit 174 included in the control interface 102. Alternatively, the deduction members 161, 163 and the determination member 166 are at least partially made in the form of programmable logic components, or in the form of dedicated integrated circuits, included in the control interface 102.

The device 100 also comprises an avionics parameter collector 180 and a command limiter 182.

The collector 180 is suitable for collecting avionics parameters of the aircraft. “Avionics parameters” refer to the information produced by the avionics systems of the aircraft and in particular relative to:

the configuration of the aircraft, i.e., the deployed or retracted state of a plurality of members of the aircraft such as the leading-edge slats, the landing gear and/or the flaps,

the state of the aircraft, i.e., the operating or failure state of each piece of flight equipment of the aircraft,

the mission context, i.e., in particular the flight plan programmed into the flight management system 103,

environmental data, i.e., the weather conditions encountered by the aircraft, as well as the instructions sent to the aircraft by the air control systems,

the current altitude of the aircraft, and

the flight phase of the aircraft.

To that end, the collector 180 is in communication with avionics systems of the aircraft, such as the flight management system 103, and is suitable for receiving avionics parameters from these avionics systems. The collector 180 is also configured to send these collected avionics parameters to the command limiter 182.

The command limiter 182 is configured to restrict the adjustment possibilities of the flying parameters, in particular configuration of the flying modes, based on the avionics parameters collected by the collector 180.

To that end, the command limiter 182 comprises a compatibility checker 186 to identify flying parameters compatible or incompatible with the collected avionics parameters, and a constraint establisher 188 configured to establish constraints to prevent the user or an avionics system of the aircraft from entering a flying parameter that is not a compatible parameter.

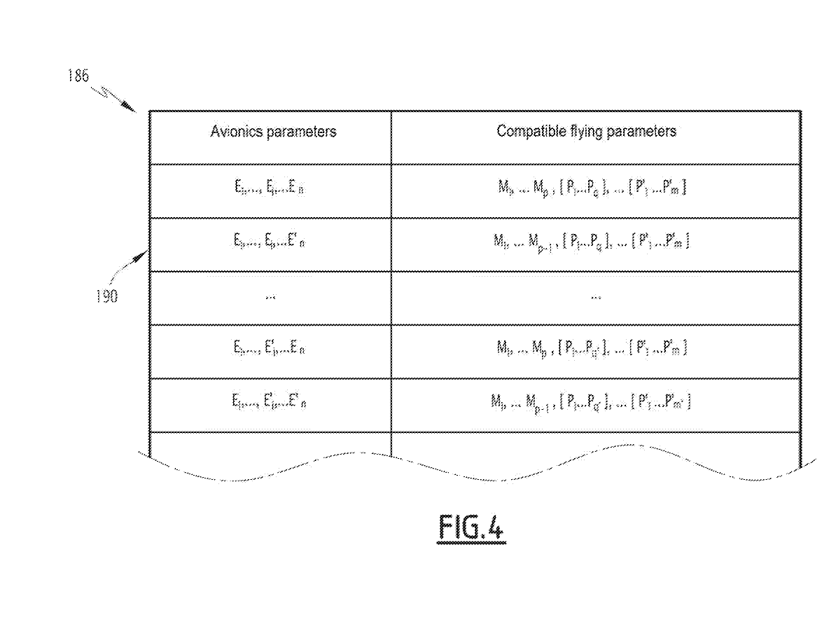

In reference to FIG. 4, the compatibility checker 186 typically comprises a database 190 indicating, for each possible combination of avionics parameters, E₁, . . . , E₁, Eₙ, the associated compatible flying parameters M₁, . . . , Mₚ, . . . , [P₁ . . . P_{q}], [P′₁ . . . P′ₘ], said compatible flying parameters comprising compatible flying modes M₁, . . . , Mₚ and compatible flying setpoint ranges [P₁ . . . P_{q}], . . . , [P′₁ . . . P′ₘ]. Thus, in the illustrated example, the database 190 indicates that, for a combination of avionics parameters E₁, . . . , Eᵢ, . . . , Eₙ, the associated compatible flying parameters are the flying modes M₁, . . . , Mₚ, and the flying setpoint ranges [P₁ . . . P_{q}], . . . , [P′₁ . . . P′ₘ], and that, in the case where the avionics parameter E′ₙ is replacing the avionics parameter E, the flying mode Mₚ is no longer compatible. The database 190 also indicates that, in the case where the avionics parameter E′ᵢ replaces the avionics parameter Eᵢ, the range of compatible flying setpoints [P₁ . . . P_{q}] has been restricted to [P₁ . . . P_{q}′] and that, in the case where, once the avionics parameter E′ₙ has replaced the avionics parameter Eₙ and the avionics parameter E′ᵢ has replaced the avionics parameter Eᵢ, not only is the flying mode Mₚ no longer compatible and the compatible flying setpoint range [P₁ . . . P_{q}] has been restricted to [P₁ . . . P_{q}′], but in addition, the compatible flying setpoint range [P′₁ . . . P′ₙ] has been restricted to [P′₁ . . . P′_{m′}].

The compatibility checker 186 is configured to identify the flying parameters compatible with the collected avionics parameters as being made up of the compatible parameters associated by the database 190 with the combination of avionics parameters made up of said collected avionics parameters.

Returning to FIG. 3, the constraint establisher 188 is suitable for receiving the compatible flying parameters identified by the compatibility checker 186. It is also configured to restrict the available flying modes selectable by the pilot via the interface 102 to only the compatible flying mode(s) M₁, . . . , Mₚ identified by the compatibility checker 186, and to restrict the authorized flying setpoint ranges to the compatible flying setpoint ranges [P₁ . . . P_{q}], . . . , [P′₁ . . . P′ₙ] identified by the compatibility checker 186.

In the example embodiment of the invention, the collector 180 and the command limiter 182 are made in the form of software programs stored in a memory 192 and able to be executed by a processor 194, associated with the memory 192, the processor 194 and the memory 192 together forming an information processing unit 196 included in the assistance device 100. Alternatively, the collector 180 and the command limiter 182 are at least partially made in the form of programmable logic components, or in the form of dedicated integrated circuits, included in the assistance device 100.

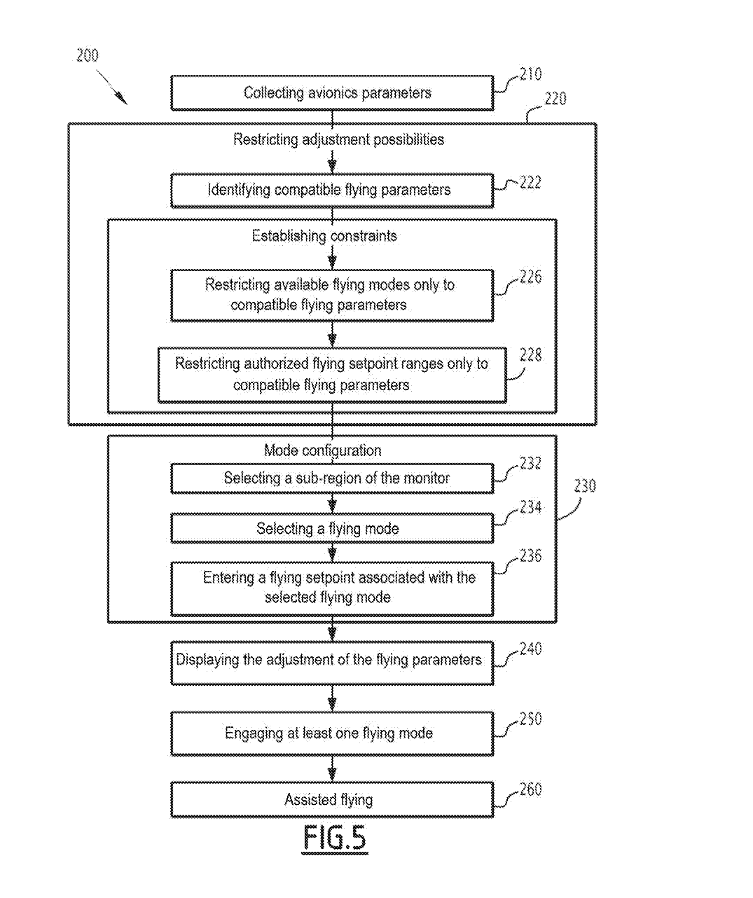

A method 200 for assisting with piloting implemented by the assistance device 100 will now be described, in reference to FIG. 5.

The method 200 begins with a first step 210 for collecting avionics parameters via the collector 180. During this step, the collector 180 receives avionics parameters from the avionics systems, which for example include the safety altitude and the current altitude of the aircraft, this current altitude here being lower than the safety altitude.

This first step 210 is followed by a step 220 for restricting the adjustment possibilities of the flying parameters.

The step for restricting the adjustment possibilities 220 begins with a sub-step 222 for identifying compatible flying parameters via the compatibility checker 186. To that end, the compatibility checker 186 receives the avionics parameters collected by the collector 180 and deduces the compatible flying parameters therefrom. In the example described here, the current altitude being lower than the safety altitude, the compatibility checker 186 identifies that, for the flying of the aircraft in a vertical trajectory, only the “path”, “vertical speed”, “climb” and “ALT” modes are compatible with the collected avionics parameters and that, for the “path”, “vertical speed” modes, only the flying setpoints having positive values are compatible with the collected avionics parameters.

Sub-step 222 is followed by a sub-step 224 for establishing constraints to prevent the user or an avionics system of the aircraft from entering a flying parameter that is not a compatible parameter.

In the described example, this step 224 comprises a first sub-step 226 for restricting the available flying modes solely to the compatible flying parameters, during which the constraint establisher 188 restricts the available flying modes only to the compatible flying modes, such that the pilot cannot select an incompatible flying mode. This first sub-step 226 is followed by a sub-step 228 for restricting the authorized setpoint ranges only to the compatible flying parameters, during which the constraint establisher 188 restricts the ranges of authorized setpoints solely to the compatible setpoint ranges, such that the pilot and the avionics systems of the aircraft cannot select an incompatible flying setpoint.

In the example described here, the flying modes available to fly the aircraft in terms of vertical trajectory are thus restricted solely to the “path”, “vertical speed”, “climb” and “ALT” flying modes, and the authorized setpoint ranges associated with the “path” and “vertical speed” flying modes are restricted to positive values only.

The restriction step 220 is followed by a mode configuration step 230. This configuration step 230 comprises a first sub-step 232 for selection by the pilot, using one of the sub-region selectors 140, of the first or second sub-region 126, 127 of one of the regions 120, 122, 124 of the monitor 112, followed by a second selection sub-step 234, still by the pilot, using one of the mode selectors 142, of a flying mode selected from among the available flying modes, which in turn is followed by a third sub-step 236 for entering a flying setpoint associated with the selected flying mode.

During the first sub-step 232, the pilot selects the first or second sub-region 126, 127 of one of the regions 120, 122, 124 of the monitor 112, the sub-region 126 or 127 thus selected determining whether the configured flying mode will be an active flying mode or an armed flying mode. In the example described here, the pilot chooses the first sub-region 126 of the fourth region 122, such that the configured flying mode will be an active flying mode intended to fly the aircraft along the vertical trajectory.

During the second sub-step 234, the pilot chooses a flying mode from among the available flying modes. In the example described here, the only flying modes available to fly the aircraft in terms of vertical trajectory being the “path”, “vertical speed”, “climb” and “ALT” flying modes, the pilot chooses one of these modes, for example the “vertical speed” mode.

During the third sub-step 236, the pilot uses the input member 144 to select a flying setpoint from within the range of authorized setpoints associated with the selected flying mode. In the example illustrated here, the range of authorized setpoints associated with the “vertical speed” mode being restricted solely to setpoints having a positive value, the pilot chooses a positive speed value as setpoint. Alternatively, the selection of the flying setpoint within the range of authorized setpoints is made using an avionics system of the aircraft, for example the CPDLC.

Step 230 is followed by a step 240 for showing the pilot the adjustment of the flying parameters, i.e., the configured flying modes and their configurations. During this step 240, the configured flying modes are displayed in the third, fourth and fifth regions 120, 122, 124 of the monitor 112, as well as their respective flying setpoints.

The display step 240 is followed by a step 250 for engaging at least one of the active flying modes. During this step 250, the pilot engages at least one active flying mode using the mode engagement system 132 and the engagement/disengagement system 134 of the flying sy stem 104.

The engagement step 250 is followed by an assisted flying step 260. During this step 260, the aircraft is guided by the automatic pilot system 104 based on the flying setpoints associated with the engaged flying modes.

Owing to the method and system described above, the risks of flying errors are reduced, since neither the pilot nor the avionics systems can enter a flying parameter that is incompatible with the avionics parameters of the aircraft.

Furthermore, the pilot's workload is lightened, since he has a synthetic view of the adjustment of the flying parameters. This again results in decreasing the risks of flying errors.

In the example provided above, it has been described that the compatibility checker 186 was identifying the flying parameters compatible with the collected avionics parameters. It will, however, be noted that the invention is not limited solely to this embodiment and that, alternatively, the compatibility checker 186 does not identify the flying parameters that are compatible with the collected avionics parameters, but the flying parameters that are incompatible with the collected avionics parameters.

What is claimed is:

1. A flying assistance method for assisting flying of an aircraft, the aircraft comprising an automatic pilot system with a plurality of preprogrammed flying modes, the flying assistance method comprising the following steps:
configuring at least one flying mode so as to form a configured flying mode, the configuring comprising:
selecting, by a user, a selected flying mode from among at least one available flying mode taken from among the preprogrammed flying modes, and
inputting at least one flying setpoint associated with the selected flying mode;
presenting, to the user, the or each configured flying mode and the associated flying setpoint;
engaging at least one configured flying mode, the configured flying mode becoming an engaged flying mode;
flying of the aircraft by the automatic pilot system based on the flying setpoint of the or each engaged flying mode;
collecting at least one avionics parameter representative of a flying context; and
restricting configuration possibilities of the flying modes based on the or each collected avionics parameter.

2. The flying assistance method according to claim 1, wherein the restricting of configuration possibilities comprises the following sub-steps:
identifying at least one flying parameter compatible or incompatible with the or each collected avionics parameter, and
establishing constraints to prevent the selection of a flying mode and/or the entry of a flying setpoint that is not a compatible flying parameter.

3. The flying assistance method according to claim 2, wherein the establishing of constraints comprises restricting the available flying modes to only the compatible flying parameters.

4. The flying assistance method according to claim 1, wherein the inputting the or each flying setpoint associated with the selected flying mode comprises selecting the flying setpoint from within a range of authorized flying setpoints, and establishing constraints comprises restricting the range of authorized flying setpoints only to the compatible flying parameters.

5. The flying assistance method according to claim 1, wherein presenting the or each configured flying mode comprises displaying the configured flying mode and the associated flying setpoint on a monitor.

6. The flying assistance method according to claim 5, wherein, to select the selected flying mode, the user interacts with a configuration system, the configuration system being formed by the monitor or by a dedicated interface system.

7. The flying assistance method according to claim 1, wherein the preprogrammed flying modes comprise at least one flying mode from among the following modes: roll mode, heading mode, track mode, path mode, vertical speed mode, climb mode, descent mode, ALT mode, speed mode, Mach mode, approach mode, LNAV mode, VNAV mode and SNAV mode.

8. The flying assistance method according to any claim 1, wherein the collected avionics parameter(s) comprise at least one avionics parameter from among: a configuration of the aircraft, a state of the aircraft, a mission context of the aircraft, environmental data of the aircraft, a current altitude of the aircraft and a current flight phase of the aircraft.

9. A flying assistance device for assisting flying of an aircraft, comprising:
a memory in which a plurality of preprogrammed flying modes are stored;
a mode configuration system for configuring at least one flying mode, so as to form a configured flying mode, the control interface comprising:
a flying mode selector for the selection, by a user, of a selected flying mode from among at least one available flying mode taken from among the preprogrammed flying modes, and
a setpoint input member for the input, by a user or by an avionics system, of at least one flying setpoint associated with the selected flying mode;
a presentation member for presenting, to the user, the or each configured flying mode and the associated flying setpoint;
a mode engaging system for engaging at least one configured flying mode, the configured flying mode becoming an engaged flying mode;
an automatic pilot system of the aircraft, configured to fly the aircraft based on the flying setpoint of the or each engaged flying mode;
an avionics parameter collector to collect at least one avionics parameter of the aircraft; and
a command limiter to restrict the flying mode configuration possibilities based on the or each collected avionics parameter.

10. The flying assistance device according to claim 9, wherein the command limiter comprises a compatibility checker to identify at least one flying parameter compatible or incompatible with the or each collected avionics parameter, and a constraint establisher configured to establish constraints to prevent the selection of a flying mode and/or the entry of a flying setpoint that is not a compatible flying parameter.

11. The flying assistance device according to claim 10, wherein the constraint establisher is configured to restrict the available flying modes to only the compatible flying parameters.

12. The flying assistance device according to claim 9, wherein the setpoint input member is suitable for allowing the selection of the flying setpoint associated with the selected flying mode selected from within a range of authorized flying setpoints, and the constraint establisher is configured to restrict the range of authorized flying setpoints only to the compatible flying parameters.

13. The flying assistance device according to claim 9, wherein the display member comprises a monitor and a control module configured to control the display, on the monitor, of the or each configured flying mode and the associated flying setpoint.

14. The flying assistance device according to claim 13, wherein the mode configuration system is formed by the monitor or by a dedicated interface system.

15. The flying assistance device according to claim 9, wherein the preprogrammed flying modes comprise at least one flying mode from among the following modes: “roll ” mode, “heading” mode, “track” mode, “path” mode, “vertical speed” mode, “climb” mode, “descent” mode, “ALT mode”, “speed” mode, “Mach” mode, “approach” mode, “LNAV” mode, “VNAV” mode and “SNAV” mode.

16. The flying assistance device according to claim 9, wherein the collected avionics parameter(s) comprise at least one avionics parameter from among: a configuration of the aircraft, a state of the aircraft, a mission context of the aircraft, environmental data of the aircraft, a current altitude of the aircraft and a current flight phase of the aircraft.
